(19) United States
(12) Patent Application Publication
(10) Pub. No.: US 2023/0041097 A1
(43) Pub. Date: Feb. 9, 2023

(54) ADVERTISING DATABASE MANAGEMENT SYSTEM AND METHOD

(71) Applicant: Good-Loop Ltd., Edinburgh (GB)

(72) Inventor: Daniel Ben Winterstein, Edinburgh (GB)

(21) Appl. No.: 17/880,936

(22) Filed: Aug. 4, 2022

Related U.S. Application Data
(60) Provisional application No. 63/229,701, filed on Aug. 5, 2021.

(51) Int. Cl. G06Q 30/02; G06F 16/951

(52) U.S. Cl. CPC G06Q 30/0271; G06F 16/951; G06Q 30/0272

(57) ABSTRACT

A computer-implemented method, computer program product and computing system for obtaining a plurality of queries from a plurality of advertisers for user-specific information from a plurality of user profiles. The plurality of queries may be processed to generate bespoke query responses for each of the plurality of advertisers based upon, at least in part, a plurality of user-specific information constraints defined within each user profile. The plurality of bespoke query responses may be provided to the plurality of advertisers.

### RELATED APPLICATION(S)

This application claims the benefit of U.S. Provisional Application No. 63/229,701 filed on 5 Aug. 2021, the entire contents of which are incorporated herein by reference.

### TECHNICAL FIELD

This disclosure relates to advertising database systems and methods and, more particularly, for managing advertising database systems and methods to provide data provenance and quality data.

### BACKGROUND

Much of the internet is funded via advertisement revenue, wherein such advertisements are often inserted/provided when viewers are reviewing online content. These advertisements may be static advertisements and/or video advertisements that may be presented to the viewer in various ways (e.g., popup windows, banner ads, embedded video content, etc.).

The specific advertisements that are presented to the viewer may be governed by manual advertisement insertion deals between the publishers of online content and various advertising entities. Unfortunately, such advertisements are often seen by the viewer as an annoyance/interruption, as there is not incentivization for the viewer to review the advertisement. Furthermore, advertising entities face significant technological hurdles when generating or maintaining data associated with particular viewers in order to provide the mist relevant content. For example, conventional database approaches utilize either single record views or data lakes which pose significant data consistency and query access problems (i.e., unable to effectively link related data for a particular person in the case of a single record view approach while being able to efficiently query data for the particular person in a data lake approach).

### SUMMARY OF DISCLOSURE

In one implementation, a computer-implemented method is executed on a computing device and includes obtaining a plurality of queries from a plurality of advertisers for user-specific information from a plurality of user profiles. The plurality of queries may be processed to generate bespoke query responses for each of the plurality of advertisers based upon, at least in part, a plurality of user-specific information constraints defined within each user profile. The plurality of bespoke query responses may be provided to the plurality of advertisers.

One or more of the following features may be included. Each query of the plurality of queries may include one or more of: a request for user identification information; a minimum accuracy value for the user-specific information; target location information; and target demographic information. A user profile may be generated with a plurality of portions of user-specific information and the plurality of user-specific information constraints. Generating the user profile may include generating the plurality of portions of user-specific information with provenance information. Generating the user profile may include generating the plurality of portions of user-specific information with probability-based accuracy information. Generating the user profile may include generating pricing information associated with the user-specific information based upon, at least in part, the probability-based accuracy information. The plurality of user-specific information constraints include permission information associated with accessing particular portions of the user-specific information. Processing the plurality of queries to generate bespoke query responses for each of the plurality of advertisers may include selectively filtering portions of the user-specific information from inclusion in the bespoke query responses based upon, at least in part, the plurality of user-specific information constraints.

In another implementation, a computer program product resides on a computer readable medium and has a plurality of instructions stored on it. When executed by a processor, the instructions cause the processor to perform operations including obtaining a plurality of queries from a plurality of advertisers for user-specific information from a plurality of user profiles. The plurality of queries may be processed to generate bespoke query responses for each of the plurality of advertisers based upon, at least in part, a plurality of user-specific information constraints defined within each user profile. The plurality of bespoke query responses may be provided to the plurality of advertisers.

One or more of the following features may be included. Processing the advert target information to generate bespoke advert target information for each of the plurality of advertisers may include generating a plurality of user profiles with a plurality of portions of user-specific information and the plurality of user-specific information constraints for each user profile. Generating the user profile may include generating the plurality of portions of user-specific information with provenance information. Generating the user profile may include generating the plurality of portions of user-specific information with probability-based accuracy information. Generating the user profile may include generating pricing information associated with the user-specific information based upon, at least in part, the probability-based accuracy information. The plurality of user-specific information constraints include permission information associated with accessing particular portions of the user-specific information. Processing the advert target information to generate bespoke advert target information for each of the plurality of advertisers may include selectively filtering portions of the user-specific information from inclusion in the bespoke advert target information for each of the plurality of advertisers based upon, at least in part, the plurality of user-specific information constraints. Identifying the plurality of advertisers for providing the advertisement to the viewer of the content may include identifying, for each advertiser, one or more of: request for user identification information; a minimum accuracy value for the user-specific information; target location information; and target demographic information.

In another implementation, a computing system includes a processor and a memory system configured to perform operations including obtaining a plurality of queries from a plurality of advertisers for user-specific information from a plurality of user profiles. The plurality of queries may be processed to generate bespoke query responses for each of the plurality of advertisers based upon, at least in part, a plurality of user-specific information constraints defined within each user profile. The plurality of bespoke query responses may be provided to the plurality of advertisers.

One or more of the following features may be included. Processing the advert target information to generate bespoke advert target information for each of the plurality of advertisers may include generating a plurality of user profiles with a plurality of portions of user-specific information and the plurality of user-specific information constraints for each user profile. Generating the user profile may include generating the plurality of portions of user-specific information with provenance information. Generating the user profile may include generating the plurality of portions of user-specific information with probability-based accuracy information. Generating the user profile may include generating pricing information associated with the user-specific information based upon, at least in part, the probability-based accuracy information. The plurality of user-specific information constraints include permission information associated with accessing particular portions of the user-specific information. Processing the advert target information to generate bespoke advert target information for each of the plurality of advertisers may include selectively filtering portions of the user-specific information from inclusion in the bespoke advert target information for each of the plurality of advertisers based upon, at least in part, the plurality of user-specific information constraints. Identifying the plurality of advertisers for providing the advertisement to the viewer of the content may include identifying, for each advertiser, one or more of: request for user identification information; a minimum accuracy value for the user-specific information; target location information; and target demographic information.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an database management process according to an embodiment of the present disclosure;

FIG. 2 is a diagrammatic view of an advertisement auction platform accessible by the database management process of FIG. 1 according to an embodiment of the present disclosure;

FIG. 3 is a flowchart of the database management process of FIG. 1 according to an embodiment of the present disclosure;

FIGS. 4-5 are diagrammatic views of an advertisement auction platform accessible by the database management process of FIG. 1 according to an embodiment of the present disclosure;

FIG. 6 is a flowchart of the database management process of FIG. 1 according to an embodiment of the present disclosure; and

FIGS. 7-8 are diagrammatic views of an advertisement auction platform accessible by the database management process of FIG. 1 according to an embodiment of the present disclosure.

Like reference symbols in the various drawings indicate like elements.

### DETAILED DESCRIPTION OF THE PREFERRED EMBODIMENTS

System Overview

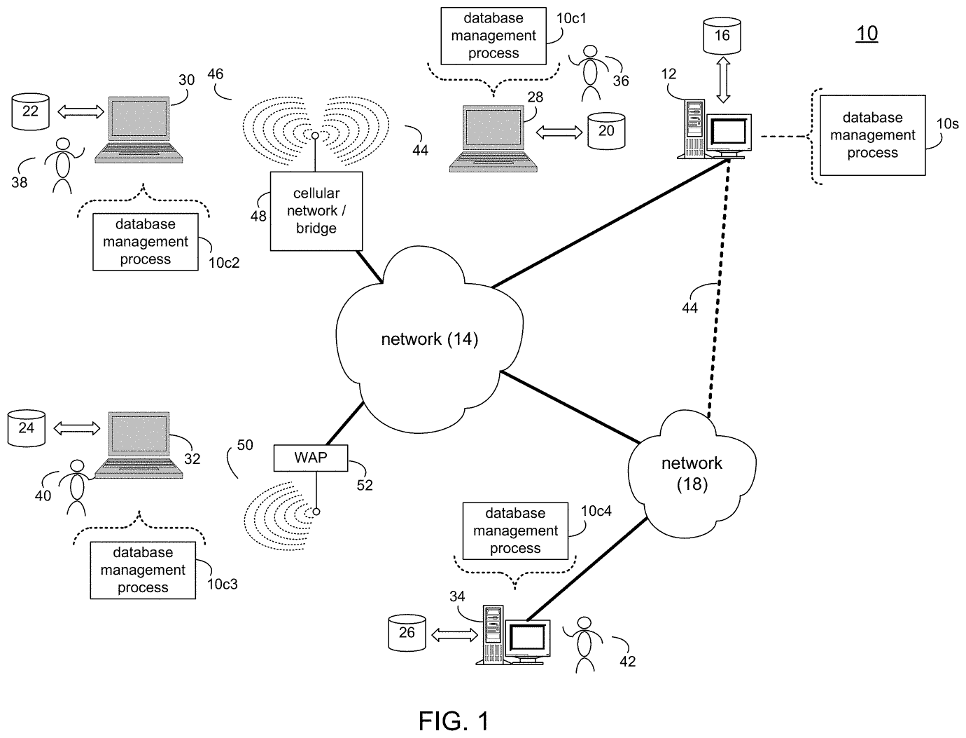

Referring to FIG. 1, there is shown database management process 10. Database management process 10 may be implemented as a server-side process, a client-side process, or a hybrid server-side/client-side process. For example, database management process 10 may be implemented as a purely server-side process via database management process 10s. Alternatively, database management process 10 may be implemented as a purely client-side process via one or more of database management process 10c1, database management process 10c2, database management process 10c3, and database management process 10c4. Alternatively still, database management process 10 may be implemented as a hybrid server-side/client-side process via database management process 10s in combination with one or more of database management process 10c1, database management process 10c2, database management process 10c3, and database management process 10c4. Accordingly, database management process 10 as used in this disclosure may include any combination of database management process 10s, database management process 10c1, database management process 10c2, database management process 10c3, and database management process 10c4.

Database management process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, a smartphone, or a cloud-based computing platform.

The instruction sets and subroutines of database management process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of database management processes 10c1, 10c2, 10c3, 10c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX™ platform). The instruction sets and subroutines of database management processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to, a smartphone (not shown), a personal digital assistant (not shown), a tablet computer (not shown), laptop computers 28, 30, 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access database management process 10 directly through network 14 or through secondary network 18. Further, database management process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and laptop computer 30 are shown wirelessly coupled to network 14 via wireless communication channels 44, 46 (respectively) established between laptop computers 28, 30 (respectively) and cellular network/bridge 48, which is shown directly coupled to network 14. Further, laptop computer 32 is shown wirelessly coupled to network 14 via wireless communication channel 50 established between laptop computer 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between laptop computer 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

Traditional Advertising Auction Process (Overview)

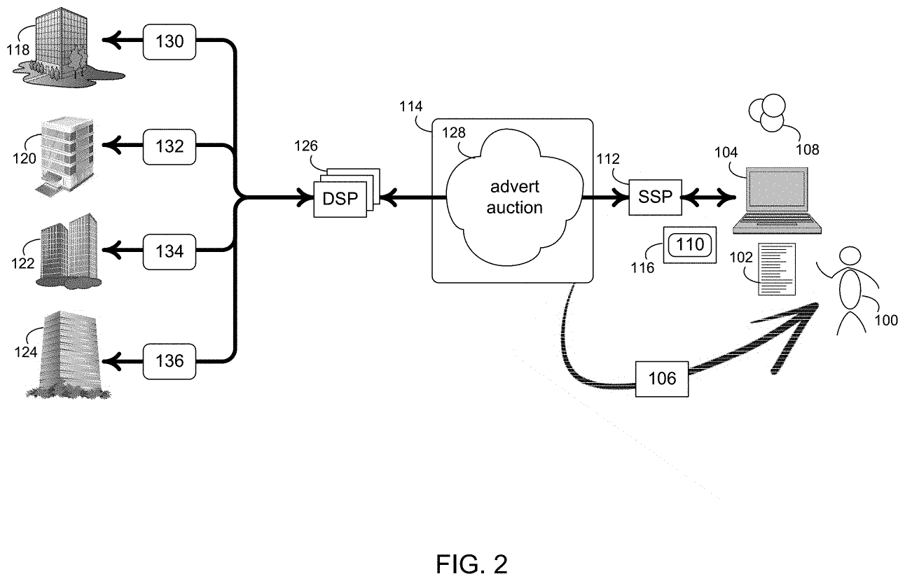

Referring also to FIG. 2, assume for illustrative purposes that a viewer (e.g., viewer 100) is viewing content (e.g., content 102) on a computing platform (e.g., platform 104). Examples of content 102 may include but are not limited to audio content, video content, graphical content and/or text-based content. Examples of platform 104 may include but are not limited to: a personal computer, a laptop computer, a notebook computer, a tablet computer, a smartphone, or a cloud-based computing platform.

As is known in the art, advertisements (e.g., advertisement 106) are typically targeted toward the likes and the interests of the recipient of the advertisement. Examples of advertisement 106 may include but are not limited to audio advertisements, video advertisements, graphical advertisements and/or text-based advertisements. Accordingly, the publisher of content 102 may identify the subject matter of content 102 so that advertisements (e.g., advertisement 106) related to the subject matter of content 102 may be directed to the viewer (e.g., viewer 100). Therefore, if the viewer (e.g., viewer 100) is reviewing content (e.g., content 102) concerning sailboats, database management process 10 may provide sailboat-related advertisements (e.g., advertisement 106) to viewer 100; if the viewer (e.g., viewer 100) is reviewing content (e.g., content 102) concerning cars, database management process 10 may provide car-related advertisements (e.g., advertisement 106) to viewer 100; and if the viewer (e.g., viewer 100) is reviewing content (e.g., content 102) concerning sports, database management process 10 may provide sports-related advertisements (e.g., advertisement 106) to viewer 100. Accordingly, database management process 10 may monitor the content (e.g., content 102) that the viewer (e.g., viewer 100) is reviewing and provide advertisements (e.g., advertisement 106) to viewer 100 that are related to that content (e.g., content 102).

For the following example, assume that the viewer (e.g., viewer 100) is reading a web-based article (e.g., content 102) concerning sailboats on their laptop computer (e.g., platform 104). Further assume that their laptop computer (e.g., platform 104) includes various cookies (e.g., cookies 108) that identify the viewer (e.g., viewer 100) as a 35-45 year old male who lives in Connecticut and their laptop computer (e.g., platform 104) as a HP™ model ABC123 that is running Windows 11™.

As is known in the art, cookies (e.g., cookies 108) are text files with small pieces of data (e.g., a username, a password, demographic information) that are used to improve a viewer's experience as the viewer uses e.g., a computer network, a computer application, and/or a website by identifying the viewer (e.g., viewer 100), the viewer's computer (e.g., platform 104) and the viewer's preferences in general. Data stored in a cookie (e.g., cookies 108) may be created by a remote server (not shown) upon connection, wherein this data may be labeled with an ID unique to the viewer (e.g., viewer 100) and their computer (e.g., platform 104). When cookies (e.g., cookies 108) are exchanged between platform 104 and the remote server (not shown), the remote server (not shown) may read the information included within the cookies (e.g., cookies 108) so that the remote server (not shown) knows what information to serve to the viewer (e.g., viewer 100).

This information (e.g., demographic information concerning viewer 100; viewing information concerning content 102; and/or platform information concerning platform 104) may be packaged to form advert target information 110. Accordingly, advert target information 110 may identify the viewer (e.g., viewer 100) and define what they are currently doing and what platform they are currently using, wherein this advert target information 110 may be used to provide advertisements (e.g., advertisement 106) to viewer 100 that are related to that content (e.g., content 102).

Advert target information 110 may be provided, via supply side platform (SSP) 112, to auction platform 114. For example, advert target information 110 may be defined within an advert auction offer (e.g., advert auction offer 116) that is provided to auction platform 114. As is known in the art, supply side platform 112 is a platform that enables publishers (e.g., publishers of content 102) to sell advertising space (via auction platform 114) to the consumers (e.g., viewer 100) of such content (e.g., content 102), thus providing an advertiser (e.g., one of advertisers 118, 120, 122, 124) with the ability to provide e.g., advertisement 106 to viewer 100.

Demand side platform (DSP) 126 may enable the advertisers (e.g., one of advertisers 118, 120, 122, 124) to buy media space (via auction platform 114), thus enabling one of the advertisers (e.g., one of advertisers 118, 120, 122, 124) to provide e.g., advertisement 106 to viewer 100.

As is known in the art, auction platform 114 is a marketplace where DSPs (e.g., demand side platform 126) and SSPs (e.g., supply side platform 112) trade, usually via auctions (e.g., primary advert auction 128). For example and continuing with the above-discussed example in which viewer 100 is reading content 102 concerning sailboats on platform 104, the publisher of content 102 may provide advert target information 110 to auction platform 114 via supply side platform 112. Advert target information 110 may define viewer 100 as a 35-45 year old male who lives in Connecticut and uses an HP™ model ABC123 laptop (e.g., platform 104) that is running Windows 11™ to review content 102, which is an article about single person sailboats.

Accordingly, auction platform 114 may initiate advert auction 128 to enable the advertisers to submit bids (e.g., bids 130, 132, 134, 136) concerning advert auction 128, wherein these bids (e.g., bids 130, 132, 134, 136) may define the amount that an advertiser is willing to pay for the ability to provide e.g., advertisement 106 to viewer 100. For example, assume that:
advertiser 118 submits a bid (e.g., bid 130) of $0.01 for the ability to provide advertisement 106 to viewer 100, as advertiser 118 is slightly interested because content 102 concerns sailboats . . . so advertiser 118 wants to insert an advertisement (e.g., advertisement 106) for a US-based sailboat company they represent;
advertiser 120 submits a bid (e.g., bid 132) of $0.03 for the ability to provide advertisement 106 to viewer 100, as advertiser 120 is moderately interested because content 102 concerns sailboats and viewer 100 is located in Connecticut . . . so advertiser 120 wants to insert an advertisement (e.g., e.g., advertisement 106) for a local Connecticut sailboat company they represent;
advertiser 122 submits a bid (e.g., bid 134) of $0.08 for the ability to provide advertisement 106 to viewer 100, as advertiser 122 is highly interested because content 102 concerns sailboats and viewer 100 is a 30-40 year old male . . . so advertiser 122 wants to insert an advertisement (e.g., e.g., advertisement 106) for a Rhode Island-based sailing school they represent; and
advertiser 124 submits a bid (e.g., bid 136) of $0.10 for the ability to provide advertisement 106 to viewer 100, as advertiser 124 is extremely interested because content 102 concerns sailboats and viewer 100 is a 30-40 year old male who lives in Connecticut . . . so advertiser 124 wants to insert an advertisement (e.g., e.g., advertisement 106) for a Connecticut-based sailing school they represent.

Auction platform 114 may review these bids (e.g., bids 130, 132, 134, 136) and select the highest bid (e.g., bid 136) and the high bidder (e.g., advertiser 124) as the winner of advert auction 128, thus providing advertiser 124 with the ability to provide advertisement 106 (e.g., an advertisement for a Connecticut-based sailing school that advertiser 124 represents) to viewer 100 of content 102.

Enhanced Advertising Database Management Process

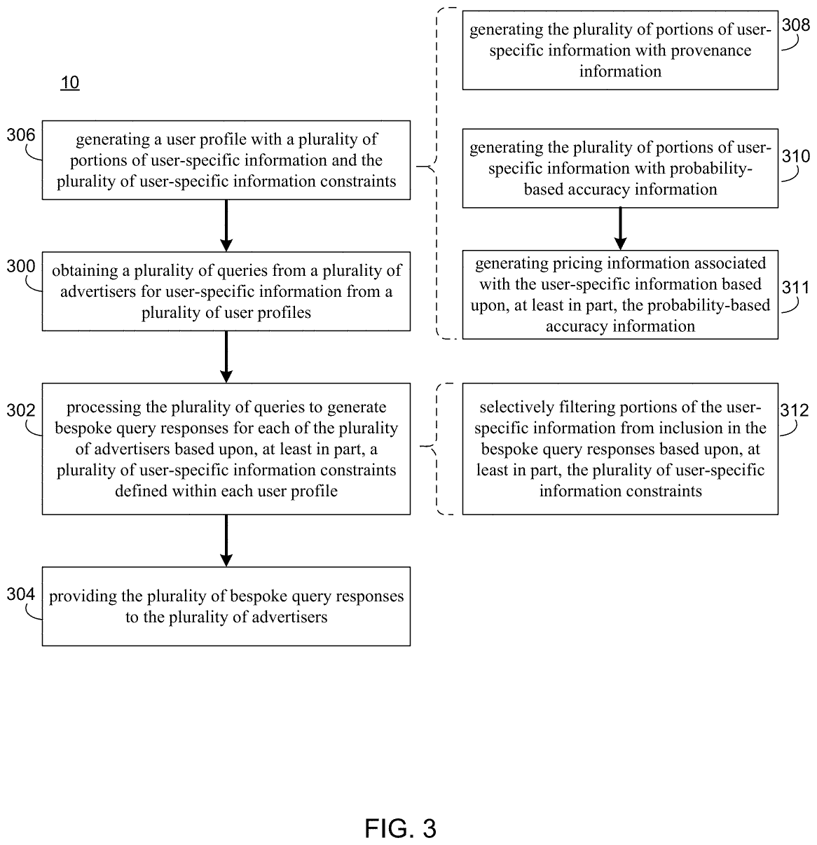

Referring also to FIGS. 3-5 and in some implementations, database management process 10 may obtain 300 a plurality of queries from a plurality of advertisers for user-specific information from a plurality of user profiles. The plurality of queries may be processed 302 to generate bespoke query responses for each of the plurality of advertisers based upon, at least in part, a plurality of user-specific information constraints defined within each user profile. The plurality of bespoke query responses may be provided 304 to the plurality of advertisers.

As will be discussed in greater detail below, implementations of the present disclosure may allow the generation of advertising databases with user profile and behavioral data that can represent at a fact-by-fact level: data provenance information (i.e., where did this fact come from?); data permission information (i.e., the privacy rules and pay-to-use costs); data quality information (i.e., how reliable is each fact?); and data redundancy/conflict information. Database management process 10 provides an improvement in database technology by modelling data provenance and quality as part of the core datastore at the level of specific entries or facts with support for overlapping values for discrete facts. In this manner, database management process 10 provides a “provenance and probability enhanced view” (PPEV) database for user profiles with user-specific information. In this manner, database management process 10 provides per-user profile and per-fact data as individual obtainable units from the PPEV database. Accordingly, database management process 10 allows for improvements in data storage and bespoke access to particular facts/portions of user-specific information from the PPEV database.

Referring to FIG. 3, database management process 10 may obtain 300 a plurality of queries from a plurality of advertisers for user-specific information from a plurality of user profiles. For example and as discussed above, a plurality of advertisers (e.g., advertisers 118, 120, 122, 124) may seek to obtain user-specific information from particular sources. In one example, the plurality of advertisers (e.g., advertisers 118, 120, 122, 124) provide a plurality of queries (e.g., queries 400, 402, 404, 406) to a PPEV database (e.g., PPEV database 408). In some implementations, each query of the plurality of queries may include one or more of: a request for user identification information; a minimum accuracy value for the user-specific information; target location information; and target demographic information. For example, suppose an advertiser (e.g., advertisers 118, 120, 122, 124) is seeking to initiate a targeted marketing campaign for a new product. In this example, each advertiser may include various computing devices configured to initiate a client-side database management process 10 to generate each query depending on the requirements specified by the advertiser. For example, database management process 10 may provide an interface (e.g., user interface or other command entry) to receive various parameters for requesting user-specific information from a PPEV database (e.g., PPEV database 408). Examples of the query parameters may include, but are not limited to, a request for user identification information (i.e., information concerning the identity of a particular individual); a minimum accuracy value for the user-specific information (i.e., a threshold degree of accuracy in the user-specific information); target location information (i.e., target city, target state, maximum geographic radius from target location, etc.); and target demographic information (e.g., age, income, race, gender, marital status, etc.). While several examples have been given of query parameters, it will be appreciated that these are for example purposes only and that any number or type of parameter may be used within the scope of the present disclosure.

As discussed above, a PPEV database (e.g., PPEV database 408) may include a “provenance and probability enhanced view” (PPEV) database for user profiles with user-specific information. For example, conventional databases are typically organized as either a collection of single customer views/single record views or a data lake. A single record view is generally a spreadsheet with one row for each person and columns for each property associated with that person. With a single record view, discrete data sources generally do not join or aggregate together cleanly. For example, when data is collected with data access constraints (e.g., General Data Protection Regulation (GDPR) compliant permissions, California Consumer Privacy Act (CCPA) permissions, Health Insurance Portability and Accountability Act (HIPAA) permissions, etc.), merging this data with other data that does not have such restrictions generally results in breached compliance. Further, particular individuals may have the same name and/or same address information. Additionally, individuals may have multiple pieces of concurrent contact information (i.e., multiple phone numbers or email addresses) that may be represented as separate individuals. As a result, single record view databases contain both false data and missed data (duplicate records which should have been linked). Moreover, there is no way to trace the permissions for a particular fact. Accordingly, adding more data can reduce the amount of data compliant to data access restrictions (e.g., GDPR, CCPA, HIPAA, etc.) within a user profile. In contrast with a single record view database, a data lake may represent a database where documents are stored roughly as-is and indexed. A search for a name brings up a list of documents. As such, the contents of a data lake database are unorganized and difficult to search effectively.

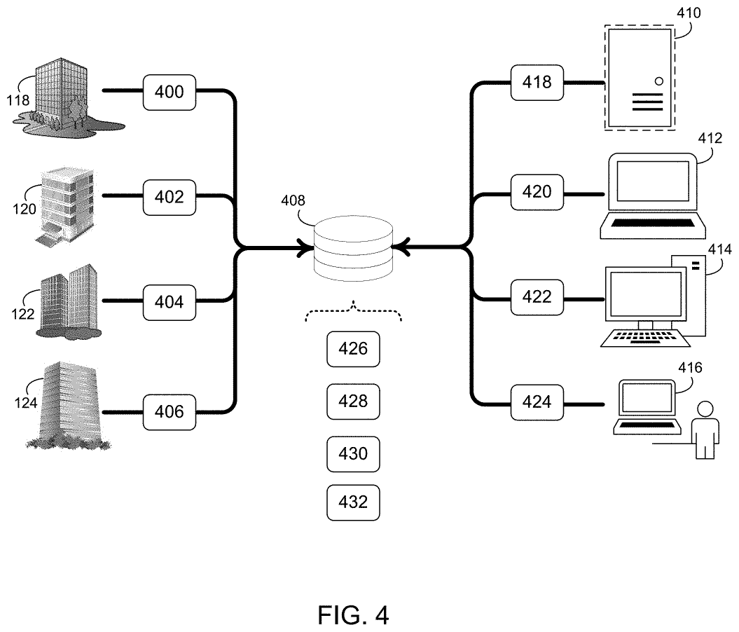

In some implementations, database management process 10 may generate 306 a user profile with a plurality of portions of user-specific information and the plurality of user-specific information constraints. For example, the PPEV database (e.g., PPEV database 408) may keep separate records for different sources (i.e., like a data lake database), but merges information from other sources (i.e. like a single record view database). However, the PPEV database may maintain provenance, quality information, and/or probability-based accuracy information at a per-fact or per-entry level. A user profile may generally represent a collection of facts or entries associated with a particular individual or entity. While FIG. 4 shows PPEV database 408 as a single data structure, it will be appreciated that PPEV database 408 may a cloud-based data structure that is distributed across various servers and/or other remote storage devices that appears to be a single data structure when processing queries. As such, it will be appreciated that PPEV database 408 may include any number and combination of discrete servers, cloud components, and storage devices within the scope of the present disclosure.

In some implementations, generating 306 the user profile may include generating 308 the plurality of portions of user-specific information with provenance information. Provenance information may generally include metadata associated with each fact or portion of user-specific information within the user profile that describes the origin, changes to, and other factors that may impact the integrity of the particular portions of the user-specific information. For example, database management process 10 may, for each portion of user-specific information associated with a particular individual or entity, may generate provenance information indicating where and when that portion of user-specific information was created, accessed, etc. In this manner, the provenance information may include source information associated with each fact or portion of user-specific information within the user profile.

In some implementations, generating 306 the user profile may include generating 310 the plurality of portions of user-specific information with probability-based accuracy information. Probability-based accuracy information may generally include a metric or representation of the likelihood that a portion of user information is correct or accurate. For example, database management process 10 may utilize the provenance information (i.e., source information) for each fact or portion of the user-specific information and determine the likelihood that the fact/portion of user-specific information is accurate. In one example, database management process 10 may communicate with a rules list or database of accuracy information for particular sources to generate 310 the probability-based accuracy information. However, it will be appreciated that database management process 10 may generate 310 the probability-based accuracy information for each fact/portion of user-specific information in various ways within the scope of the present disclosure.

In some implementations, generating 306 the user profile includes generating 311 pricing information associated with the user-specific information based upon, at least in part, the probability-based accuracy information. For example, each fact or portion of user-specific information may have different value to different entities. In one example, an individual's mailing address may be particularly meaningful for mailing printed marketing materials while less meaningful for a targeted electronic newsletter. In another example, an individual's date of birth may be known which may be more valuable than a potential age range. As such, database management process 10 may, in some implementations, utilize various automated pricing mechanisms to define and/or adjust pricing information associated with each portion of user-specific information. In one example, the automated pricing mechanisms utilize the probability-based accuracy information to adjust the pricing (e.g., a higher price for user-specific information that is more accurate or a lower price for user-specific information that is less accurate). In this manner, database management process 10 may account for data accuracy in the pricing information provided to querying entities (e.g., advertisers 118, 120, 122, 124). Additionally, this dynamic pricing information may resolve issues with conventional database systems where data is assumed to be of a poor accuracy or quality (as the data is not verified and does not include an accuracy metric).

In some implementations, the probability-based accuracy information may be utilized to perform automatic data quality control on user-specific information. For example, suppose database management process 10 receives a first portion of user-specific information that indicates an individual's last name. Now suppose that a significant portion of time passes and a second portion of user-specific information is received and indicates a change in the individual's last name. In this example, database management process 10 may utilize various known machine learning models or other artificial intelligence engines coupled with various rules to modify the user-specific information over time and/or in light of other or newer user-specific information. Continuing with the above example, suppose that the initial probability-based accuracy associated with the individual's last name was e.g., 75% likely. However, in light of the new individual's last name received with a probability-based accuracy of 95% (e.g., a marriage record), database management process 10 may perform automated quality control on the user-specific information by modifying the user-specific information based upon, at least in part, the probability-based accuracy information (e.g., by lowering the probability-based accuracy of the prior last name to 25%). In this manner, database management process 10 may dynamically perform quality control on the user-specific information using the probability-based accuracy information.

In some implementations and as discussed above, individual facts or portions of user-specific information may include data access constraints or restrictions. For example and as discussed above, certain user-specific information may be more sensitive or private than other pieces of information. In one example, these user-specific information constraints may be legally defined (e.g., GDPR, HIPAA, etc.) and when the associated user-specific information is generated or stored, database management process 10 may generate the user-specific information constraint as an entry in the user profile. In another example, the user-specific information constraints may be user-defined and/or generated automatically by database management process 10. For example, when a user enters an email address into a subscription-based form, database management process 10 may indicate the permissions associated with the user's email address (i.e., access to the email is granted for a particular company's marketing service) in the user-specific information constraint generated for the user's email address. Accordingly and in some implementations, the plurality of user-specific information constraints may include permission information associated with accessing particular portions of the user-specific information. In this manner, database management process 10 may determine, for each portion of user-specific information, whether or not to provide access to that portion of information to e.g., a particular advertiser. As will be discussed in greater detail below, when processing queries on a user profile, database management process 10 may utilize the plurality of user-specific information constraints associated with each portion of user-specific information to selectively filter that fact or portion of user-specific information for a response to a particular query.

An example of a portion of user-specific information stored in PPEV database 408 is shown below:
id: customer3672,
data-provider: ACME company,
name: [
   {name: “Alice Jones”, source: web-form, accuracy: 60%}
   {name: “Alice”, source: Email, accuracy: 70%}
   {name: “A Smith”, source: Visa-card, accuracy: 99%}
],
relationship-status: [{status: married, sources: [name-change-inference-bot, webform, Visa-credit-card], accuracy: 65%}],
sources: [
   web-form: {permissions: private-to-company, updated: 4 years ago}
   Email: {permissions: marketing+3rd party use, updated: 1 year ago}
   Visa-card: {permissions: private-to-company, updated: 1 month ago}
   name-change-inference-bot: {permissions: all}
]

In the above example fact or portion of user-specific information stored in PPEV database 408, note the multiple individual entries under “name” that account for various versions of the user's name with different probability-based accuracies. Similarly, note that the portion of user-specific information concerning an individual's relationship status includes various entries reflect different sources and user-specific information constraints. While examples of a user's name and relationship status are shown for two portions of the user-specific information in the example user profile, it will be appreciated that any number or type of user-specific information may be stored within the PPEV database within the scope of the present disclosure.

Referring again to FIG. 4 and in some implementations, database management process 10 may generate 306 and/or modify the PPEV database (e.g., PPEV database 408) by receiving various portions of user-specific information (e.g., user-specific information portions 418, 420, 422, 424) from various sources (e.g., sources 410, 412, 414, 416). Examples of these sources may include, but are not limited to, data supply services, electronic directories, legal directories, servers utilized by business entities, etc. In this manner, database management process 10 may generate 306 various user profiles (e.g., user profiles 426, 428, 430, 432) with discrete facts or portions of user-specific information by importing the discrete portions of user-specific information from the plurality of sources (e.g., sources 410, 412, 414, 416). In some implementations, database management process 10 may be configured to request data from or automatically “crawl” the plurality of sources to generate the plurality of user profiles (e.g., user profiles 426, 428, 430, 432). As such, it will be appreciated that database management process 10 may generate 306 the plurality of user profiles with various portions of user-specific information in many ways within the scope of the present disclosure.

In some implementations, database management process 10 may process 302 the plurality of queries to generate bespoke query responses for each of the plurality of advertisers based upon, at least in part, a plurality of user-specific information constraints defined within each user profile. As discussed above, a plurality of advertisers (e.g., advertisers 118, 120, 122, 124) may send or otherwise provide various queries (e.g., queries 400, 402, 404, 406) for user-specific information from a plurality of user profiles (e.g., user profiles 426, 428, 430, 432). For example, suppose advertiser 118 requests targeted delivery of a message to people according to personal information about them (e.g., “men over 30”). In this example, database management process 10 may include this request in the form of various query parameters. In another example, suppose advertiser 118 wants to advertise sailboats in a particular city. In this example, advertiser 118 may be willing to accept user-specific location information with a lower accuracy for a lower price. By contrast, another advertiser may seek specific delivery addresses and, as such, may require a high accuracy. In this manner, database management process 10 may process 302 various queries with distinct parameters to generate bespoke query responses for each advertiser.

In some implementations, processing 302 the plurality of queries to generate bespoke query responses for each of the plurality of advertisers may include selectively filtering 312 portions of the user-specific information from inclusion in the bespoke query responses based upon, at least in part, the plurality of user-specific information constraints. For example, database management process 10 may utilize the query parameters of each query and the plurality of user-specific information constraints to selectively filter 312 portions of the user-specific information from inclusion in the bespoke query responses.

As discussed above, database management process 10 may utilize the probability-based accuracy information to perform automated quality control in real-time during the processing of queries. For example, suppose a query is received for an individual's mailing address for inclusion in a printed mailing marketing campaign. In this example, database management process 10 may be selectively filter 312 portions of the user-specific information from inclusion in the bespoke query responses based upon, at least in part, the probability-based accuracy information. In one example, database management process 10 may utilize the most accurate version of a particular portion of user-specific information by selectively filtering all but the most accurate user-specific information. In another example, database management process 10 may provide different pricing information in response to the query where the most accurate user-specific information has a high price while the less accurate user-specific information has a low price. In this manner, database management process 10 may dynamically utilize the probability-based accuracy information when processing 302 the plurality of queries.

Referring again to FIG. 4, suppose that advertiser 118 represents a US-based sailboat company; advertiser 120 represents a Connecticut-based sailboat company; advertiser 122 represents a Rhode Island-based sailing school; and advertiser 124 represents a Connecticut-based sailing school. In this example, each advertiser may have separate interests in their target advertising audience. For example, suppose that query 400 from advertiser 118 specifies a request for the email addresses of individuals who own a sailboat anywhere in the United States for a mailing list. Suppose that query 402 from advertiser 120 specifies a request for the individuals who live in New England who own a sailboat for inclusion in a targeted marketing campaign. Further suppose that query 404 from advertiser 122 specifies a request for individuals who live in Rhode Island, Connecticut, and Massachusetts that have a sailboat and have children in for a targeted mailing marketing campaign for a series of summer sailing school classes for children in Rhode Island. Finally, suppose that query 406 from advertiser 124 specifies a request for individuals who live in Connecticut, Rhode Island, and New York who have medical training for fulfilling a medical-based employment opportunity available at a Connecticut-based sailing school. As each of these queries include specific parameters, database management process 10 may process 302 the plurality of queries (e.g., queries 400, 402, 404, 406) by selectively filtering 312 portions of the user-specific information for and/or from inclusion in the bespoke query responses.

For example, database management process 10 may process 302 the plurality of queries (e.g., queries 400, 402, 404, 406) to determine the query parameters for each query and may utilize these query parameters to search PPEV database 408. Continuing with the above example, database management process 10 may query each of the plurality of user profiles (e.g., user profiles 426, 428, 430, 432) for particular user-specific information portions that satisfy the plurality of query parameters. Additionally, database management process 10 may process 302 the plurality of user-specific information constraints to determine whether a particular portion should be selectively filtered 312 from inclusion in the plurality of bespoke query responses. For example, database management process 10 may process each portion of the user-specific information of user profile 426 to determine the user-specific information constraints associated with that portion. In one example, suppose that user profile 426 indicates that the email address of user profile 426 may be shared with any requesting entity. In another example, suppose that user profiles 428, 430, 432 each indicate that their email address is not to be shared with anyone. In this example, database management process 10 may selectively filter 312 the email address of user profiles 428, 430, 432 from the bespoke query response for query 400.

Continuing with the above example where query 402 from advertiser 120 specifies a request for the individuals who live in New England who own a sailboat for inclusion in a targeted marketing campaign, database management process 10 may process 302 the plurality of user-specific information constraints to determine whether a particular portion should be selectively filtered 312 from inclusion in the plurality of bespoke query responses. For example, database management process 10 may process each portion of the user-specific information of user profile 426 to determine the user-specific information constraints associated with that portion. In one example, suppose that user profile 426 indicates that the email address of user profile 426 may be shared with any requesting entity. However, suppose that user profile 426 includes location information indicating that the user lives in Virginia (i.e., outside of New England). In this example, database management process 10 may selectively filter the email address of user profiles 426, 428, 430, 432 from the bespoke query response for query 402.

Continuing with the above example where query 404 from advertiser 122 specifies a request for individuals who live in Rhode Island, Connecticut, and Massachusetts that have a sailboat and have children in for a targeted mailing marketing campaign for a series of summer sailing school classes for children in Rhode Island, database management process 10 may process 302 the plurality of user-specific information constraints to determine whether a particular portion should be selectively filtered 312 from inclusion in the plurality of bespoke query responses. For example, database management process 10 may process each portion of the user-specific information of user profile 426 to determine the user-specific information constraints associated with that portion. In one example, suppose that user profile 426 indicates that the associated individual lives in Virginia. In this example, database management process 10 may selectively filter 312 the email address of user profile 426 from the bespoke query response for query 404. However, suppose that user profiles 428, 430 indicate that the associated individuals live in Rhode Island and Connecticut, respectively. In this example, database management process 10 may also determine that the user-specific information constraints for each user profile's mailing address information permits the mailing address to be shared with advertisers. However, suppose that user profile 428 indicates a low probability that the associated individual has a child who could attend the desired sailing school while user profile 430 indicates a high probability that the associated individual of user profile 430 has children who could attend the sailing school. In this example, database management process 10 may selectively filter 312 the particular portions of user-specific information to provide in the bespoke query response.

Additionally, database management process 10 may provide different pricing requirements for the user-specific information. For example, as user profile 430 indicates a high likelihood that the associated individual has children who could attend the sailing school while user profile 428 indicates a low probability, database management process 10 may generate or reference per-user-specific information portion pricing. In this example, database management process 10 may charge one fee for the mailing address of user profile 428 and a higher fee for the mailing address of user profile 430 given the high probability of reaching the target audience. It will be appreciated that the exact fees may be determined in various ways within the scope of the present disclosure. For example, database management process 10 may employ user or supplied-defined pricing, default pricing, dynamic pricing based on e.g., demand, value of particular services or goods, probability or likelihood of including target audience, etc. In this manner, database management process 10 may provide per-fact/per-portion pricing of each portion of the user-specific information of the plurality of user profiles in the PPEV database.

Continuing with the above example where query 406 from advertiser 124 specifies a request for individuals who live in Connecticut, Rhode Island, and New York who have medical training for fulfilling a medical-based employment opportunity available at a Connecticut-based sailing school, database management process 10 may process 302 the plurality of user-specific information constraints to determine whether a particular portion should be selectively filtered 312 from inclusion in the plurality of bespoke query responses. For example, database management process 10 may process each portion of the user-specific information of user profile 426 to determine the user-specific information constraints associated with that portion. In one example, suppose that user profile 426 indicates no medical information but indicates no current employment information. In this example, the contact information for user profile 426 may be provided in the bespoke query response for query 406. Now suppose that user profiles 428, 430 indicate, with high probability, that the associated individuals of each user profile are currently employed and lack medical training. In this example, database management process 10 may selectively filter 312 the contact information for the individuals of user profiles 428, 430 from inclusion in the bespoke query response for query 406. Now suppose that user profile 432 indicates that the associated individual is currently employed but has significant medical training (i.e., with user-specific information indicating medical school graduation). In this example, database management process 10 may provide this contact information in the bespoke query response for query 406.

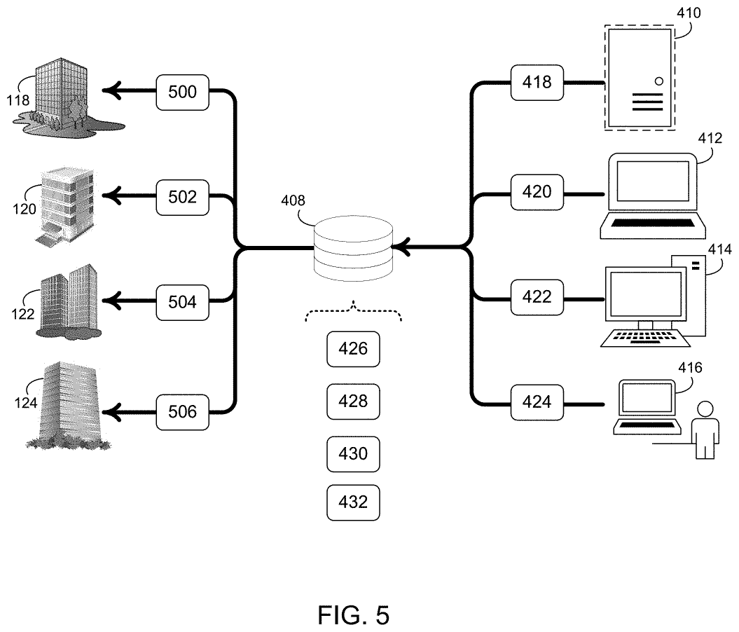

In some implementations, database management process 10 may provide 304 the plurality of bespoke query responses to the plurality of advertisers. Referring also to FIG. 5, database management process 10 may provide 304 a plurality of bespoke query responses (e.g., bespoke query responses 500, 502, 504, 506) to the plurality of advertisers (e.g., advertisers 118, 120, 122, 124). While the above examples may indicate the processing of these queries at the same time, it will be appreciated that database management process 10 may process 302 any number of queries from any number of advertisers or other entities at any time within the scope of the present disclosure. As such, any reference to advertisers is for example purposes only as any entity or individual may provide queries to PPEV database 408 within the scope of the present disclosure. With the plurality of bespoke query responses (e.g., bespoke query responses 500, 502, 504, 506), each advertiser may use the obtained user-specific information for various purposes.

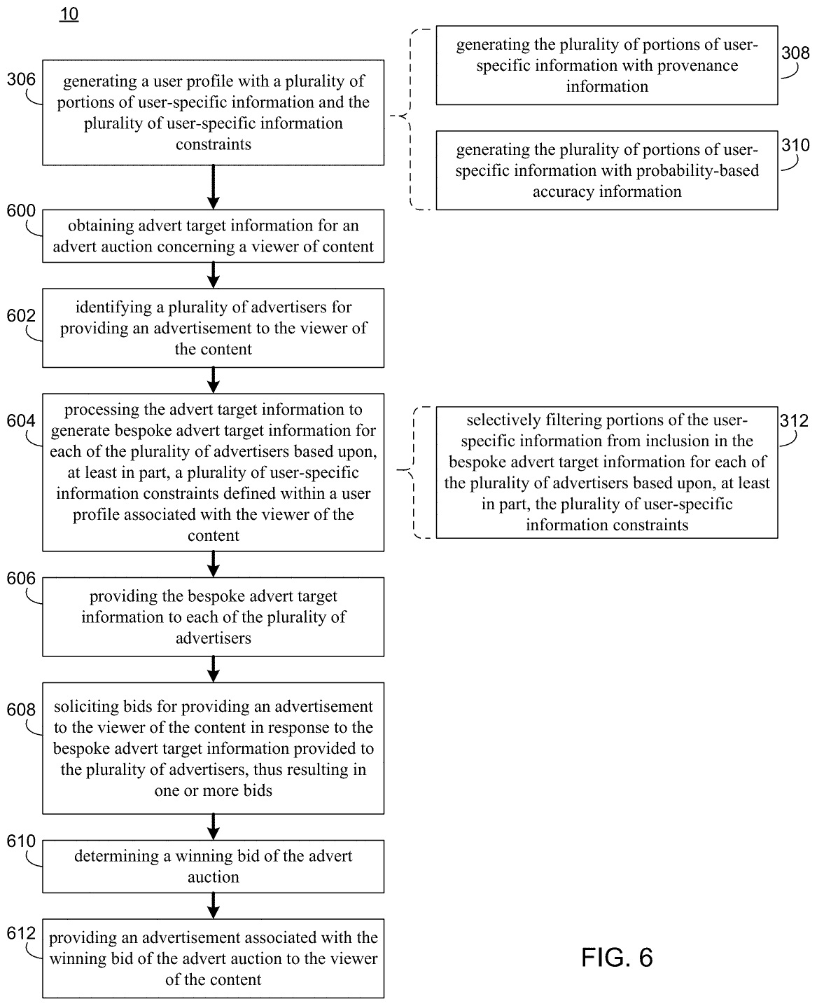

Referring also to FIGS. 6-8 and in some implementations, database management process 10 may provide advertisements (e.g., advertisement 106) to a viewer (e.g., viewer 100) that are related to the content (e.g., content 102) being viewed. For example, database management process 10 may obtain 600 advert target information for an advert auction concerning a viewer of content. As discussed above, this information (e.g., demographic information concerning viewer 100; viewing information concerning content 102; and/or platform information concerning platform 104) may be packaged to form advert target information 110. Accordingly, advert target information 110 may identify the viewer (e.g., viewer 100) and define what they are currently doing and what platform they are currently using, wherein this advert target information 110 may be used to provide advertisements (e.g., advertisement 106) to viewer 100 that are related to that content (e.g., content 102). However, various portions of user-specific information may not be determined in conventional advert target information. Additionally, not every advertiser is permitted to receive all of a user's information. Accordingly and as discussed above, database management process 10 may generate bespoke advert target information for a plurality of advertisers to account for the restrictions associated with sharing particular portions of user-specific information with various advertisers (or other entities).

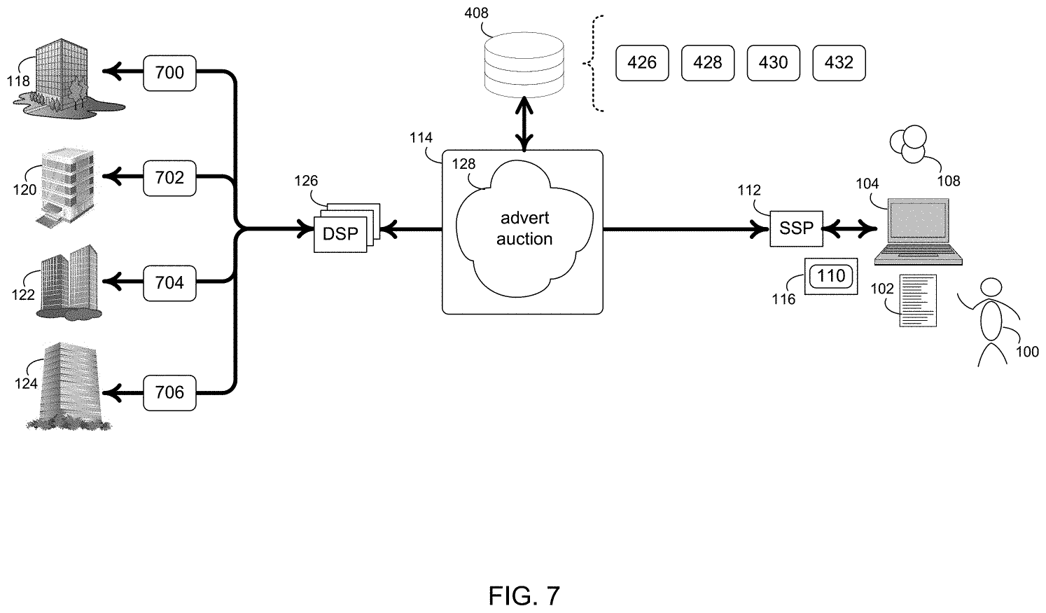

In some implementations, database management process 10 may utilize the advert target information (e.g., advert target information 110) to identify a particular individual's user profile in the PPEV database (e.g., PPEV database 408). Referring again to FIG. 7, database management process 10 may obtain 600 advert target information (e.g., advert target information 110) for an advert auction (e.g., advert auction 128) concerning a viewer (e.g., viewer 100) of content (e.g., content 102) on a computing platform (e.g., platform 104). Database management process 10 may utilize advert target information 110 to identify a particular user profile (e.g., user profiles 426, 428, 430, 432).

In some implementations, database management process 10 may identify 602 a plurality of advertisers for providing an advertisement to the viewer of the content. For example, database management process 10 may interface (e.g., via a DSP (e.g., DSP 126)) with various advertisers (e.g., advertisers 118, 120, 122, 124). In this example, database management process 10 may determine either specific advertisers and/or types of advertisers to provide bespoke advert target information for. Identifying 602 the plurality of advertisers may include generating particular constraints or limitations associated with each advertiser. For example, database management process 10 may utilize identify information for each advertiser to selectively filter advert target information for particular user profiles. In the example of FIG. 7, database management process 10 may identify advertisers 118, 120, 122, 124. While FIG. 7 shows e.g., four advertisers, it will be appreciated that database management process 10 may identify 602 any number of or type of advertisers or other entities within the scope of the present disclosure.

In some implementations, database management process 10 may process 604 the advert target information to generate bespoke advert target information for each of the plurality of advertisers based upon, at least in part, a plurality of user-specific information constraints defined within a user profile associated with the viewer of the content. For example and as discussed above, advertiser 118 may want to insert an advertisement (e.g., advertisement 106) for a US-based sailboat company they represent while advertiser 120 may want to insert an advertisement (e.g., advertisement 106) for a Connecticut-based sailboat company they represent. Additionally, advertiser 122 may desire to insert an advertisement (e.g., advertisement 106) for a Rhode Island-based sailing school they represent; and advertiser 124 may desire to insert an advertisement (e.g., advertisement 106) for a Connecticut-based sailing school they represent. In this manner, database management process 10 may process 604 the advert target information (e.g., advert target information 110) to generate bespoke advert target information (e.g., bespoke advert target information 700, 702, 704, 706) for each advertiser (e.g., advertisers 118, 120, 122, 124).

As discussed above, database management process 10 may, utilizing the identified plurality of advertisers, provide bespoke advert target information. For example, suppose that advert target information 110 defines viewer 100 as a 35-45 year old male who lives in Connecticut and uses an HP™ model ABC123 laptop (e.g., platform 104) that is running Windows 11™ to review content 102, which is an article about single person sailboats. In this example, database management process 10 may provide this advert target information with additional information from PPEV database 408 in the form of bespoke advert target information 700, 702, 704, 706. As discussed above, database management process 10 may provide particular user-specific information portions of user profile 428 associated with viewer 100 to enhance the bidding of each advertiser. For example, suppose that user-specific information within user profile 428 indicates that viewer 100 owns a sailboat and docks it in Rhode Island. In this example, database management process 10 may provide this information in bespoke advert target information 704 to enhance the probability that advertiser 122 (a Rhode Island-based sailing school) will bid higher in order to advertise to viewer 100. While an example of a user-specific information portion regarding sailboat ownership and docking has been provided, it will be appreciated that this is for example purposes only and that various portions of user-specific information may be provided to particular advertisers within the scope of the present disclosure.

In some implementations, database management process 10 may provide 606 the bespoke advert target information to each of the plurality of advertisers. Referring again to FIG. 7, database management process 10 may provide 606 the bespoke advert target information (e.g., bespoke advert target information 700, 702, 704, 706) to the plurality of advertisers (e.g., advertisers 118, 120, 122, 124). In the example of FIG. 7, advertiser 118 may be provided with bespoke advert target information 700; advertiser 120 may be provided with bespoke advert target information 702; advertiser 122 may be provided with bespoke advert target information 704; and advertiser 124 may be provided with bespoke advert target information 706.

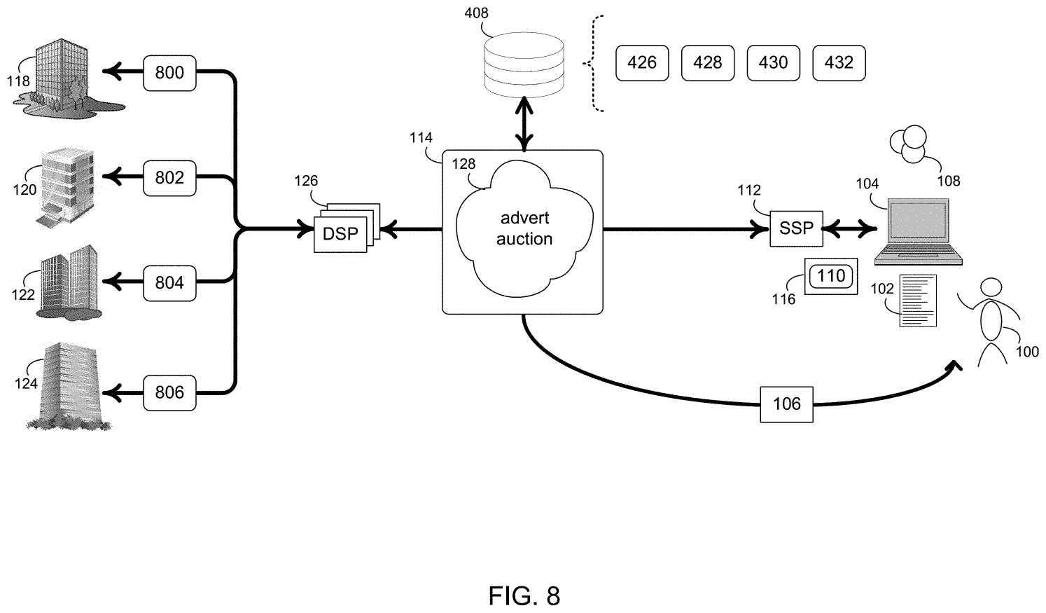

Referring also to FIG. 8 and in some implementations, database management process 10 may solicit 608 bids for providing an advertisement to the viewer of the content in response to the bespoke advert target information provided to the plurality of advertisers, thus resulting in one or more bids. In response to providing the bespoke advert target information to the plurality of advertisers, auction platform 114 may initiate advert auction 128 to enable the advertisers to submit bids (e.g., bids 800, 802, 804, 806) concerning advert auction 128, wherein these bids (e.g., bids 800, 802, 804, 806) may define the amount that an advertiser is willing to pay for the ability to provide e.g., advertisement 106 to viewer 100. For example, assume that:
advertiser 118 submits a bid (e.g., bid 800) of $0.01 for the ability to provide advertisement 106 to viewer 100, as advertiser 118 is slightly interested because content 102 concerns sailboats . . . so advertiser 118 wants to insert an advertisement (e.g., advertisement 106) for a US-based sailboat company they represent;
advertiser 120 submits a bid (e.g., bid 802) of $0.03 for the ability to provide advertisement 106 to viewer 100, as advertiser 120 is moderately interested because content 102 concerns sailboats and viewer 100 is located in Connecticut . . . so advertiser 120 wants to insert an advertisement (e.g., e.g., advertisement 106) for a local Connecticut sailboat company they represent;
advertiser 122 submits a bid (e.g., bid 804) of $0.15 for the ability to provide advertisement 106 to viewer 100, as advertiser 122 is highly interested because content 102 concerns sailboats and viewer 100 owns a sailboat and stores his boat in Rhode Island . . . so advertiser 122 wants to insert an advertisement (e.g., e.g., advertisement 106) for a Rhode Island-based sailing school they represent; and
advertiser 124 submits a bid (e.g., bid 806) of $0.10 for the ability to provide advertisement 106 to viewer 100, as advertiser 124 is extremely interested because content 102 concerns sailboats and viewer 100 is a 30-40 year old male who lives in Connecticut . . . so advertiser 124 wants to insert an advertisement (e.g., e.g., advertisement 106) for a Connecticut-based sailing school they represent.

Auction platform 114 may review these bids (e.g., bids 800, 802, 804, 806) and may determine 610 a winning bid of the advert auction by selecting the highest bid (e.g., bid 804) and the high bidder (e.g., advertiser 122) as the winner of advert auction 128, thus providing advertiser 124 with the ability to provide 612 advertisement 106 (e.g., an advertisement for a Rhode Island-based sailing school that advertiser 122 represents) to viewer 100 of content 102.

### GENERAL

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method executed on a computing device comprising:
obtaining a plurality of queries from a plurality of advertisers for user-specific information from a plurality of user profiles;
processing the plurality of queries to generate bespoke query responses for each of the plurality of advertisers based upon, at least in part, a plurality of user-specific information constraints defined within each user profile; and
providing the plurality of bespoke query responses to the plurality of advertisers.

2. The computer-implemented method of claim 1 wherein each query of the plurality of queries includes one or more of:
a request for user identification information;
a minimum accuracy value for the user-specific information;
target location information; and
target demographic information.

3. The computer-implemented method of claim 1 further comprising:
generating a user profile with a plurality of portions of user-specific information and the plurality of user-specific information constraints.

4. The computer-implemented method of claim 3 wherein generating the user profile includes generating the plurality of portions of user-specific information with provenance information.

5. The computer-implemented method of claim 3 wherein generating the user profile includes generating the plurality of portions of user-specific information with probability-based accuracy information.

6. The computer-implemented method of claim 5 wherein generating the user profile includes generating pricing information associated with the user-specific information based upon, at least in part, the probability-based accuracy information.

7. The computer-implemented method of claim 1 wherein the plurality of user-specific information constraints include permission information associated with accessing particular portions of the user-specific information.

8. The computer-implemented method of claim 1 wherein processing the plurality of queries to generate bespoke query responses for each of the plurality of advertisers includes:
selectively filtering portions of the user-specific information from inclusion in the bespoke query responses based upon, at least in part, the plurality of user-specific information constraints.

9. A computer program product residing on a non-transitory computer readable medium having a plurality of instructions stored thereon which, when executed by a processor, cause the processor to perform operations comprising:
obtaining advert target information for an advert auction concerning a viewer of content;
identifying a plurality of advertisers for providing an advertisement to the viewer of the content;
processing the advert target information to generate bespoke advert target information for each of the plurality of advertisers based upon, at least in part, a plurality of user-specific information constraints defined within a user profile associated with the viewer of the content;
providing the bespoke advert target information to each of the plurality of advertisers;
soliciting bids for providing an advertisement to the viewer of the content in response to the bespoke advert target information provided to the plurality of advertisers, thus resulting in one or more bids;
determining a winning bid of the advert auction; and
providing an advertisement associated with the winning bid of the advert auction to the viewer of the content.

10. The computer program product of claim 9 wherein processing the advert target information to generate bespoke advert target information for each of the plurality of advertisers includes:
generating a plurality of user profiles with a plurality of portions of user-specific information and the plurality of user-specific information constraints for each user profile.

11. The computer program product of claim 10 wherein generating the user profile includes generating the plurality of portions of user-specific information with provenance information.

12. The computer program product of claim 10 wherein generating the user profile includes generating the plurality of portions of user-specific information with probability-based accuracy information.

13. The computer program product of claim 12 wherein generating the user profile includes generating pricing information associated with the user-specific information based upon, at least in part, the probability-based accuracy information.

14. The computer program product of claim 9 wherein the plurality of user-specific information constraints include permission information associated with accessing particular portions of the user-specific information.

15. The computer program product of claim 9 wherein processing the advert target information to generate bespoke advert target information for each of the plurality of advertisers includes:
selectively filtering portions of the user-specific information from inclusion in the bespoke advert target information for each of the plurality of advertisers based upon, at least in part, the plurality of user-specific information constraints.

16. The computer program product of claim 9 wherein identifying the plurality of advertisers for providing the advertisement to the viewer of the content includes identifying, for each advertiser, one or more of:
a request for user identification information;
a minimum accuracy value for the user-specific information;
target location information; and
target demographic information.

17. A computing system including a processor and memory configured to perform operations comprising:
obtaining advert target information for an advert auction concerning a viewer of content;
identifying a plurality of advertisers for providing an advertisement to the viewer of the content;
processing the advert target information to generate bespoke advert target information for each of the plurality of advertisers based upon, at least in part, a plurality of user-specific information constraints defined within a user profile associated with the viewer of the content;
providing the bespoke advert target information to each of the plurality of advertisers;
soliciting bids for providing an advertisement to the viewer of the content in response to the bespoke advert target information provided to the plurality of advertisers, thus resulting in one or more bids;
determining a winning bid of the advert auction; and
providing an advertisement associated with the winning bid of the advert auction to the viewer of the content.

18. The computing system of claim 17 wherein processing the advert target information to generate bespoke advert target information for each of the plurality of advertisers includes:
generating a plurality of user profiles with a plurality of portions of user-specific information and the plurality of user-specific information constraints for each user profile.

19. The computing system of claim 18 wherein generating the user profile includes generating the plurality of portions of user-specific information with provenance information.

20. The computing system of claim 18 wherein generating the user profile includes generating the plurality of portions of user-specific information with probability-based accuracy information.

21. The computing system of claim 17 wherein generating the user profile includes generating pricing information associated with the user-specific information based upon, at least in part, the probability-based accuracy information.

22. The computing system of claim 17 wherein the plurality of user-specific information constraints include permission information associated with accessing particular portions of the user-specific information.

23. The computing system of claim 17 wherein processing the advert target information to generate bespoke advert target information for each of the plurality of advertisers includes:
selectively filtering portions of the user-specific information from inclusion in the bespoke advert target information for each of the plurality of advertisers based upon, at least in part, the plurality of user-specific information constraints.
